(19) United States
(12) Patent Application Publication
(10) Pub. No.: US 2013/0278650 A1
(43) Pub. Date: Oct. 24, 2013

(54) COLOR IMAGE DISPLAY DEVICE AND CONTROL METHOD THEREOF

(71) Applicants: Yuhji Takahashi, Osaka-shi (JP); Satoru Asao, Osaka-shi (JP); Yoshitomo Suzuki, Osaka-shi (JP); Nobuyuki Nakamura, Osaka-shi (JP); Kazumasa Nagayama, Osaka-shi (JP); Hiromitsu Fujinami, Osaka-shi (JP)

(72) Inventors: Yuhji Takahashi, Osaka-shi (JP); Satoru Asao, Osaka-shi (JP); Yoshitomo Suzuki, Osaka-shi (JP); Nobuyuki Nakamura, Osaka-shi (JP); Kazumasa Nagayama, Osaka-shi (JP); Hiromitsu Fujinami, Osaka-shi (JP)

(21) Appl. No.: 13/637,754

(22) PCT Filed: Jan. 21, 2011
(86) PCT No.: PCT/JP2011/051072

§ 371 Date: Nov. 30, 2012

(30) Foreign Application Priority Data
Apr. 7, 2010 (JP) 2010-088292

(51) Int. Cl. G09G 3/18

(52) U.S. Cl. CPC G09G 3/18
USPC 345/691; 345/58; 345/102

(57) ABSTRACT

In the present display device, LEDs are controlled to be lit up in an alternating manner where BG-LEDs (34) and BR-LEDs (35) are controlled to be lit up alternatingly every half of one frame period, such that only G display elements are used for display in a first subframe where the BG-LEDs (34) are lit up, and only B and R display elements are used for display in a second subframe where the BR-LEDs (35) are lit up. As a result, even in the case where crosstalk occurs (with respect to color filters of a certain color), display elements of colors for which such crosstalk can be inhibited or eliminated are simply used for display so that a reduction in color reproducibility can be inhibited or eliminated.

### TECHNICAL FIELD

The present invention relates to color image display devices and control methods thereof, particularly to a color image display device with a backlight including light sources of different colors and a control method thereof.

### BACKGROUND ART

It is often the case that an image display device, such as a liquid crystal display device, which includes a backlight, uses a white-light illumination device including LEDs (light-emitting diodes) as backlight sources. A method for obtaining such white light is described in, for example, Japanese Laid-Open Patent Publication No. 2008-140704, in which light from a blue-green (cyan) LED lamp and light from a purple (magenta) LED lamp are mixed by an additive process. The blue-green LED lamp includes a blue LED and a green phosphor to be excited by blue light therefrom (the light having a peak wavelength within the blue wavelength range), and the purple LED lamp includes a blue LED and a red phosphor to be excited by blue light therefrom. Blue light, green light, and red light emitted therefrom are mixed by an additive process, resulting in white light. This example of the conventional art will be referred to below as the first conventional example.

The configuration of the first conventional example uses no LEDs other than blue LEDs, so that a reduction in output power due to a temperature rise and an increase in cumulative lighting time can be minimized. Moreover, when compared to a white LED lamp including both a green phosphor and a red phosphor for one blue LED, blue-light use efficiency is improved, increasing optical output power.

Here, in another conventional method for obtaining white light, blue light from a blue LED and yellow light from a yellow phosphor excited by the blue light are mixed together by an additive process. However, in such a method, both red and green components are insufficient to achieve satisfactory color reproducibility with a display device.

In this regard, the first conventional example where light from the blue-green LED lamp and light from the purple LED lamp are mixed by an additive process does not suffer a deficit in red and green components. However, wavelength bands for light of these color components do not completely coincide with wavelength bands for light that can be transmitted through filters of various colors provided on liquid crystal display elements. As a result, light of two color components (e.g., blue and green light or blue and red light) might be transmitted through color filters of a certain color (e.g., green). Due to occurrence of such crosstalk (color mixing), the first conventional example has a problem of a reduction in color reproducibility. Therefore, it is often the case that a configuration as in the first conventional example employs an approach to inhibit crosstalk by increasing the attenuation rate of color filters.

Furthermore, in relevance to the present invention, Japanese National Phase PCT Laid-Open Publication No. 2008-542808 describes the configuration of a color display device in which temporal and spatial crosstalk, including the crosstalk as described above, is reduced. Specifically, this device includes two types of light sources, which emit light of different colors, and display elements with color filters of three colors, R, G, and B. In addition, all pixels are displayed with a total of six colors by dividing one frame into two subframes, such that one type of light sources are lit up in the first subframe while all of the pixels are displayed with three colors, and subsequently the other type of light sources are lit up in the second subframe while all of the pixels are displayed with three other colors. This example of the conventional art will be described below as the second conventional example.

### CITATION LIST

### Patent Document

Patent Document 1: Japanese Laid-Open Patent Publication No. 2008-140704
Patent Document 2: Japanese National Phase PCT Laid-Open Publication No. 2008-542808

### SUMMARY OF THE INVENTION

### Problems to be Solved by the Invention

Here, in the configuration of the first conventional example, a backlight with high optical output power can be used, but if the attenuation rate of the color filters is increased as described earlier, pixel luminances are significantly reduced, although crosstalk can be inhibited.

Furthermore, in the configuration of the second conventional example, there is no crosstalk between two light sources during the same subframe, but when crosstalk occurs due to light of two colors (in this conventional example, from one light source) being transmitted through color filters of a certain color, as in the first conventional example, such crosstalk cannot be inhibited, resulting in reduced color reproducibility. Accordingly, it is extremely difficult to apply the drive method of the second conventional example to drive the LED lamps in the first conventional example, thereby inhibiting a reduction in color reproducibility.

Therefore, an objective of the present invention is to provide a color image display device and a control method thereof in which blue-green LED lamps and purple LED lamps are used as backlight sources, as in the first conventional example, and the attenuation rate of color filters is increased to inhibit or eliminate crosstalk (due to two colors being transmitted through color filters of a certain color) without reducing pixel luminances, thereby inhibiting or eliminating a reduction in color reproducibility.

### Solution to the Problems

A first aspect of the present invention is directed to an active-matrix color image display device, including:

a display portion having first through third display elements arranged in a matrix, the display elements having color filters of predetermined three primary colors formed on their respective surfaces and transmitting light with transmittances in accordance with provided signals;

a drive control portion for providing the second display elements with signals for image display in a first subframe period being one of two subframe periods into which each frame period for display of one screen is divided, and also providing the first and third display elements with signals for image display in a second subframe period being the other of the two subframe periods;

a backlight portion including first illuminants for emitting light of first and second colors among the three primary colors and second illuminants for emitting light of the first color and a third color among the three primary colors, at least one of the first and second illuminants being lit up to illuminate the display portion; and

a backlight control portion for controlling the first illuminants to be lit up and the second illuminants to be turned off during the first subframe period and also controlling the first illuminants to be turned off and the second illuminants to be lit up during the second subframe period, wherein,

the drive control portion provides the first and third display elements with signals for setting their light transmittances to zero or a value close to zero in the first subframe period and also provides the second display elements with signals for setting their light transmittances to zero or a value close to zero in the second subframe period.

In a second aspect of the present invention, based on the first aspect of the invention, the first color is blue, the second color is green, and the third color is red.

In a third aspect of the present invention, based on the first aspect of the invention, the first illuminants include light-emitting diode elements for emitting the first color and first phosphors for emitting the second color when being excited by light from the light-emitting diode elements, and the second illuminants include light-emitting diode elements of the same type as the light-emitting diode elements included in the first illuminants and second phosphors for emitting the third color when being excited by light from the light-emitting diode elements included in the second illuminants.

In a fourth aspect of the present invention, based on the first aspect of the invention, the color filters formed on the first display elements transmit therethrough both light of the first color and a portion of light of the second color that has a wavelength close to the first color, and block light of the third color.

In a fifth aspect of the present invention, based on the first aspect of the invention, the backlight control portion in a predetermined first operation mode controls the first and second illuminants such that the first illuminants are lit up with the second illuminants off during the first subframe period, the first illuminants are turned off with the second illuminants lit up during the second subframe period, and in a second operation mode where the display elements have higher display luminances than in the first operation mode, the backlight control portion controls the first and second illuminants to be lit up during each frame period.

A sixth aspect of the present invention is directed to a method for controlling an active-matrix color image display device with a display portion having first through third display elements arranged in a matrix, the display elements having color filters of predetermined three primary colors formed on their respective surfaces and transmitting light with transmittances in accordance with provided signals, and a backlight portion including first illuminants for emitting light of first and second colors among the three primary colors and second illuminants for emitting light of the first color and a third color among the three primary colors, at least one of the first and second illuminants being lit up to illuminate the display portion, the method including:

a drive control step of providing the second display elements with signals for image display in a first subframe period being one of two subframe periods into which each frame period for display of one screen is divided, and also providing the first and third display elements with signals for image display in a second subframe period being the other of the two subframe periods; and

a backlight control step of controlling the first illuminants to be lit up and the second illuminants to be turned off during the first subframe period and also controlling the first illuminants to be turned off and the second illuminants to be lit up during the second subframe period, wherein,

in the drive control step, the first and third display elements are provided with signals for setting their light transmittances to zero or a value close to zero in the first subframe period, and the second display elements are provided with signals for setting their light transmittances to zero or a value close to zero in the second subframe period.

### Effect of the Invention

According to the first aspect of the present invention, in the first subframe period where the first illuminants are lit up, the drive control portion provides the second display elements with signals for image display and also provides the first and third display elements with signals for setting their light transmittances to zero or a value close to zero, and in the second subframe period where the second illuminants are lit up, the drive control portion provides the first and third display elements with signals for image display and also provides the second display elements with signals for setting their light transmittances to zero or a value close to zero, so that even in the case where crosstalk occurs (with respect to color filters of a certain color), a desired image can be displayed simply using display elements of colors for which such crosstalk can be inhibited or eliminated. Thus, a reduction in color reproducibility can be inhibited or eliminated.

According to the second aspect of the present invention, since the first color is blue, the second color is green, and the third color is red, a reduction in color reproducibility in a color image display device using typical three primary colors can be inhibited or eliminated by inhibiting or eliminating crosstalk.

According to the third aspect of the present invention, the first and second illuminants include identical light-emitting diode elements for emitting the first color, so that their temperature characteristics, aging characteristics, etc., can be rendered consistent to a certain degree. Particularly for the configuration where blue light-emitting diodes are used, it is known that a reduction in output power due to a temperature rise is less and a reduction in output power due to an increase in cumulative lighting time is extremely less when compared to general red light-emitting diodes, for example. Moreover, unlike in the configuration of a conventional white illuminant including both green and red phosphors for one light-emitting diode, efficiency reduction does not occur due to blue-green light being reabsorbed by the red phosphor (the wavelength thereof being subjected to reconversion), for example, resulting in high blue-light use efficiency, so that optical output power can be increased.

According to the fourth aspect of the present invention, the color filters formed on the first display elements block light of the third color, and therefore even in the case where the second illuminants, which emit the third color, are lit up in the second subframe period where the first display elements are provided with signals for image display, a reduction in color reproducibility with respect to the first color can be eliminated without crosstalk.

According to the fifth aspect of the present invention, in the second operation mode, the first and second illuminants are lit up during each frame period, and therefore the display luminances of the display elements can be increased where necessary, so that significant luminance changes can be accurately reproduced.

According to the sixth aspect of the present invention, the same effect as in the first aspect of the invention can be achieved by a method for controlling a color image display device.

### BRIEF DESCRIPTION OF THE DRAWINGS

FIG. 1 is a block diagram illustrating the configuration of a liquid crystal display device according to an embodiment of the present invention.

FIG. 2 is a diagram illustrating details of a backlight device in the embodiment.

FIG. 3 is a diagram illustrating the structures of a BG-LED and a BR-LED in the embodiment.

FIG. 4 is a graph showing a spectrum of light from the backlight device and light transmission characteristics (wavelength characteristics for light transmittances) of color filters on display elements in the embodiment.

FIG. 5 is a diagram showing the control timing for both a display operation of each of R, G, and B display elements and the operation of lighting up LEDs in the embodiment.

FIG. 6 is a graph showing a spectrum of light from BG-LEDs and light transmission characteristics (wavelength characteristics for light transmittances) of color filters on display elements in the embodiment.

FIG. 7 is a graph showing a spectrum of light from BR-LEDs and light transmission characteristics (wavelength characteristics for light transmittances) of color filters on display elements in the embodiment.

### MODE FOR CARRYING OUT THE INVENTION

Hereinafter, an embodiment of the present invention will be described with reference to the accompanying drawings.

<1. Overall Configuration and Outline of Operation>

FIG. 1 is a block diagram illustrating the configuration of a liquid crystal display device 2 according to an embodiment of the present invention. The liquid crystal display device 2 shown in FIG. 1 includes a backlight device 3, backlight driver circuit 4, a panel driver circuit 6, a liquid crystal panel 7, and a display control circuit 5.

The liquid crystal display device 2 receives an input image Dᵥ including R, G, and B images. Each of the R, G, and B images includes (m×n) pixel luminances. The display control circuit 5 obtains display data for use in driving the liquid crystal panel 7 (referred to below as liquid crystal data Dₐ) and backlight control data for use in driving the backlight device 3 (referred to below as timing data D_{b}) on the basis of the input image Dᵥ (details will be described later).

The liquid crystal panel 7 includes (m×n×3) display elements P. The display elements P are arranged two-dimensionally as a whole, with each row including 3m of them in its direction (in FIG. 1, horizontally) and each column including n of them in its direction (in FIG. 1, vertically). The display elements P include R, G, and B display elements having color filters respectively transmitting red, green, and blue light therethrough. The R, G, and B display elements are arranged so as to be adjacent along the row direction, and each pixel is formed by a set of these three.

Specifically, the liquid crystal panel 7 is composed of two insulating substrates, which specifically are opposed to each other. One of the substrates has scanning signal lines (gate bus lines) and video signal lines (source bus lines) provided in a grid form, and also has thin-film transistors (TFTs) provided as switching elements in the vicinity of intersections of the scanning signal lines and the video signal lines. The TFTs include gate electrodes connected to the scanning signal lines, source electrodes connected to the video signal lines, and drain electrodes. The drain electrodes are connected to pixel electrodes arranged in a matrix on the substrate for image formation. Moreover, an electrode (referred to below as a “common electrode”) is provided between the other substrate of the liquid crystal panel and the pixel electrodes via a liquid crystal layer, and pixel formation portions are realized as discrete display elements by the pixel electrodes, the common electrode, and the liquid crystal layer. Furthermore, once the gate electrodes of the TFTs receive active scanning signals (gate signals) from the scanning signal lines, voltages are applied to the liquid crystal layer in the display elements on the basis of video signals (source signals) received from the video signal lines by the source electrodes of the TFTs and a common electrode signal supplied to the common electrode. As a result, the liquid crystal is driven so that a desired image is displayed on the screen.

Note that the configuration of the color filter provided for each display element and the method for forming the filter are well-known, and therefore any descriptions thereof will be omitted herein. Moreover, the liquid crystal layer is required to be responsive at high speed, as will be described later, and therefore it is preferably an OCB (optically compensated birefringence) liquid crystal having a cell with a bend structure combined with a phase-difference film.

The panel driver circuit 6 is a circuit for driving the liquid crystal panel 7. On the basis of liquid crystal data Dₐ outputted by the display control circuit 5, the panel driver circuit 6 outputs signals (voltage signals), which control light transmittances of display elements P, to corresponding video signal lines on the liquid crystal panel 7, and also turns on the TFTs of the corresponding display elements P. The voltages outputted by the panel driver circuit 6 are written to pixel electrodes (not shown) in the display elements P, so that the light transmittances of the display elements P change in accordance with the voltages written to the pixel electrodes.

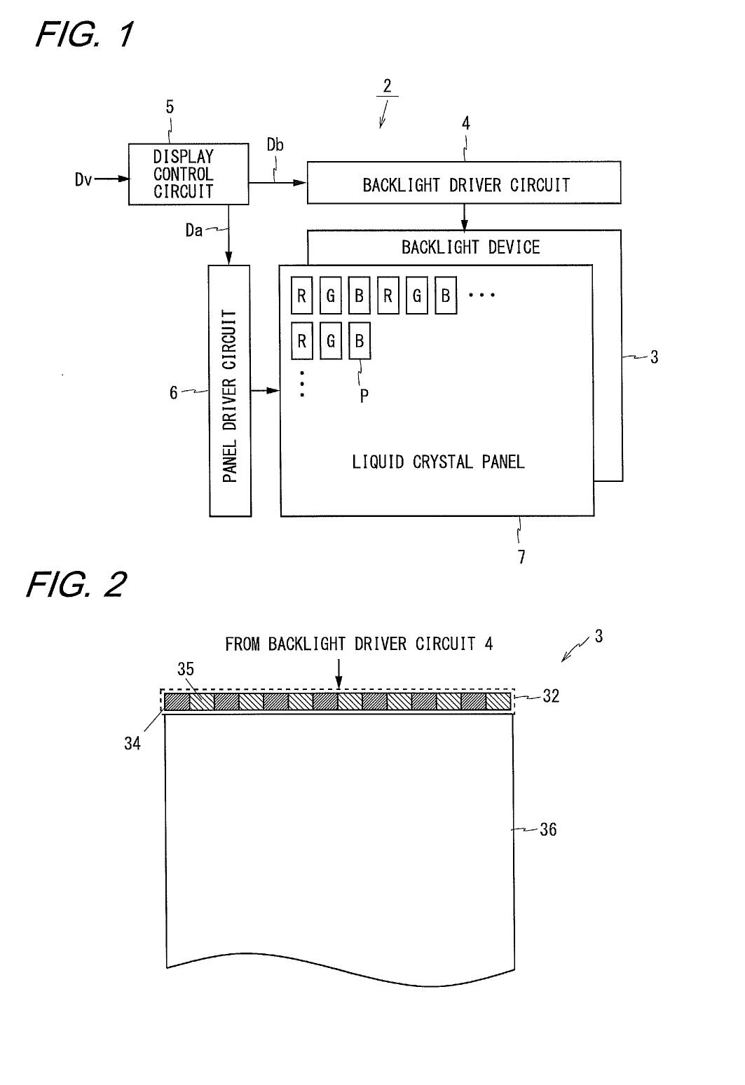

The backlight device 3 is provided on the backside of the liquid crystal panel 7, and illuminates the back of the liquid crystal panel 7 with backlight. FIG. 2 is a diagram illustrating a detailed configuration of the backlight device 3. The backlight device 3 includes an LED unit 32, which functions as a light source, and a light guide plate 36, which guides light from the LED unit 32 to the liquid crystal panel 7, as shown in FIG. 2.

The LED unit 32 includes a plurality of BG-LEDs 34 for emitting blue-green (cyan) light, and a plurality of BR-LEDs 35 for emitting purple (magenta) light. The BG-LEDs 34 and the BR-LEDs 35 are alternatingly arranged in a row along a side surface of the light guide plate 36 so as to be in close contact therewith.

The light guide plate 36 includes unillustrated optical compensation sheets, such as a diffusion sheet and a polarizing sheet, and the light guide plate 36 receives light from the side surface in close contact with the LED unit 32, and diffuses the light across the entire plane facing the liquid crystal panel 7, thereby uniformly radiating the light toward the liquid crystal panel 7.

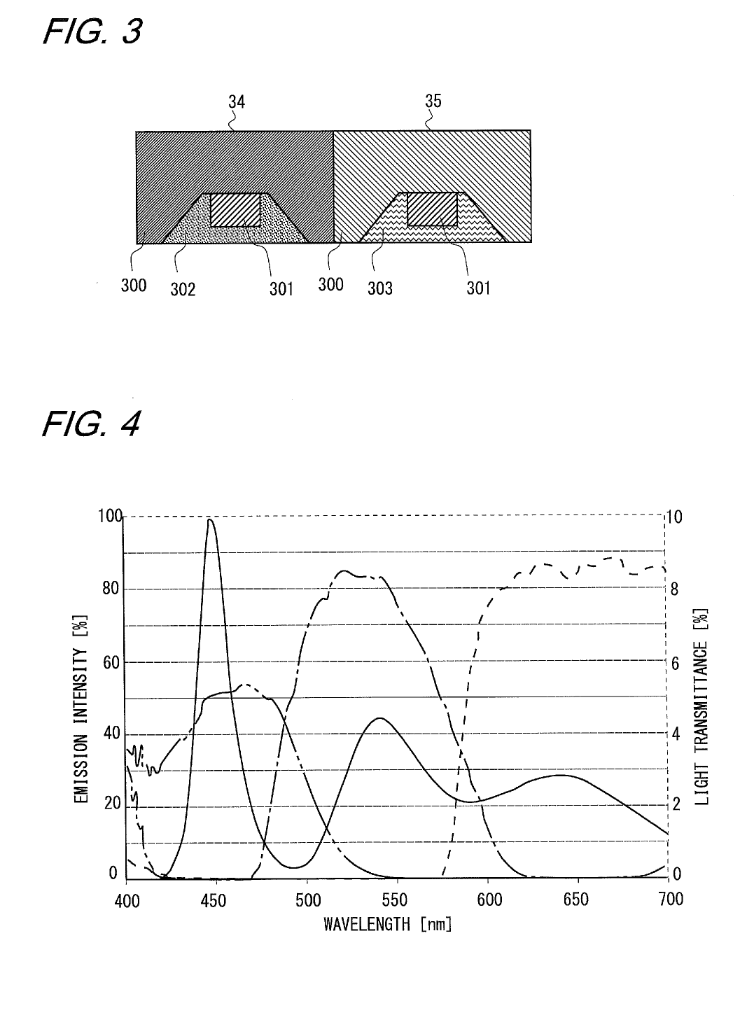

Referring now to FIG. 3, the configurations of the BG-LEDs 34 and the BR-LEDs 35 will be described in further detail. As shown in FIG. 3, each of the BG-LEDs 34 and the BR-LEDs 35 includes a housing member 300 and an LED bare chip 301 for emitting blue light, each BG-LED 34 includes a green phosphor 302, and each BR-LED 35 includes a red phosphor 303.

Note that the BG-LEDs 34 and the BR-LEDs 35 have unillustrated elements, including connection terminals, wiring electrodes, bonding wires for connecting the LED bare chips 301, etc., but any descriptions thereof will be omitted herein.

The LED bare chips 301 are blue LED elements, which are made of an InGaN material, for example, and emit blue light (the light having a peak wavelength in the blue wavelength range). The LED bare chips 301 are sealed with encapsulation resin which is translucent resin with a phosphor dispersed therein as a wavelength conversion member. In this manner, the LED bare chips 301 are used in both the BG-LEDs 34 and the BR-LEDs 35, so that their temperature characteristics, aging characteristics, etc., can be rendered consistent to a certain degree.

The green phosphors 302 sealed with the resin inside the BG-LEDs 34 are made of one of the following materials, for example, ZnS:Cu, SiAlON:Eu, and Ca3Sc2 (SiO4)3:Ce, and discharge green light (the light having a peak wavelength in the green wavelength range) subjected to wavelength conversion when they are excited by blue light from the LED bare chips 301. The BG-LEDs 34 emit blue-green light through additive mixing of the green light with part of the blue light emitted by the LED bare chips 301.

Furthermore, the red phosphors 303 sealed with the resin inside the BR-LEDs 35 are made of a CaAlSiN3:Eu material, for example, and discharge red light (the light having a peak wavelength in the red wavelength range) subjected to wavelength conversion when they are excited by blue light from the LED bare chips 301. The BR-LEDs 35 emit purple light through additive mixing of the red light with part of the blue light emitted by the LED bare chips 301.

As described above, since both the BG-LEDs 34 and the BR-LEDs 35 use the LED bare chips 301 made of an InGaN material, for example, they are known to have a lesser reduction in output power due to a temperature rise and an extremely lesser reduction in output power due to an increase in cumulative lighting time when compared to red LEDs made of an AlGaInP material, for example. Moreover, for the configuration of a conventional white LED lamp including both the green phosphor 302 and the red phosphor 303 for one LED bare chip 301, for example, it is known that blue-green light is reabsorbed (the wavelength thereof is subjected to reconversion) by the red phosphor 303, resulting in efficiency reduction, and when compared to such a configuration, the configuration of the present embodiment has higher blue-light use efficiency, and also has optical output power increased by 40% or higher.

The backlight driver circuit 4 is a circuit for driving the backlight device 3. On the basis of timing data D_{b} outputted by the display control circuit 5, the backlight driver circuit 4 outputs signals (voltage signals or current signals), which control lighting of the BG-LEDs 34 and the BR-LEDs 35 (and their emission luminances where necessary), to the backlight device 3. Note that the timing of lighting up the BG-LEDs 34 and the BR-LEDs 35 will be described in detail later.

Furthermore, on the basis of an input image Dᵥ, the display control circuit 5 obtains light transmittances of all display elements P included in the liquid crystal panel 7, and outputs liquid crystal data Dₐ, which represents the obtained light transmittances, to the panel driver circuit 6.

Here, as will be described in detail later, there are cases where the BG-LEDs 34 and the BR-LEDs 35 are lit up at the same time and where they are alternatingly lit up at predetermined times. On the basis of timing data D_{b}, the display control circuit 5 sets display tone data to 0 (black display), and the display tone data is provided to the G display elements in a predetermined period, including a period in which no BG-LEDs 34 are lit up, and also to the B and R display elements in a predetermined period, including a period in which no BR-LEDs 35 are lit up. The reason for such settings will also be described in detail later.

In the liquid crystal display device 2, the luminance of each R display element is the product of the luminance of red light emitted by the backlight device 3 and the light transmittance of the R display element. Similarly, the luminance of each G display element is the product of the luminance of green light emitted by the backlight device 3 and the light transmittance of the G display element, and the luminance of each B display element is the product of the luminance of blue light emitted by the backlight device 3 and the light transmittance of the B display element.

In the liquid crystal display device 2 thus configured, liquid crystal data Dₐ and timing data D_{b} are appropriately obtained on the basis of an input image Dᵥ, the light transmittances of the display elements P are controlled on the basis of the liquid crystal data Dₐ, and the BG-LEDs 34 and the BR-LEDs 35 are controlled on the basis of the timing data D_{b}, so that the liquid crystal panel 7 can display the input image Dᵥ. The operation by the display control circuit 5 for controlling the lighting of the LEDs will be described next along with the display luminances of the display elements of each color.

<2. Lighting and Display Luminance Control Operation by the Display Control Circuit>

The display control circuit 5 performs either the operation of controlling the BG-LEDs 34 and the BR-LEDs 35 to be lit up at the same time (this control mode being referred to below as “simultaneous lighting control”) or the operation of controlling the LEDs to be lit up alternatingly (this control mode being referred to below as “alternate lighting control”).

First, in the case of simultaneous lighting control, the display control circuit 5 controls the BG-LEDs 34 and the BR-LEDs 35 to be lit up at the same time during one frame period. In this case, the intensity of blue light being emitted by each LED bare chip 301 is greater (about two times by simple calculation) than the intensity of each of green light and red light from a corresponding phosphor. Specifically, light from the backlight device 3 is bluish-white light. Accordingly, in the case of performing such simultaneous lighting control, the display control circuit 5 uses the light transmittances of the liquid crystal elements previously determined for their respective colors in accordance with the components of light. For example, even in the case where the display elements for their respective colors provide display with the same luminance, the light transmittance of each B display element is about half of the light transmittance of each of the G and R display elements.

In the case of simultaneous lighting control, all LEDs included in the backlight device 3 are lit up, so that the maximum light intensity can be achieved. Accordingly, for example, in the case where a movie in which scenes change so fast is displayed, it is possible to accurately reproduce significant changes in luminances. In this manner, for example, in the case where high luminances are required, the display control circuit 5 performs simultaneous lighting control on the basis of, for example, a user operation for mode change selection or suchlike, and a result of a well-known characteristic determination process for image data.

In the case of simultaneous lighting control, however, crosstalk (overlapping of optical spectra) occurs between blue light and green light and between green light and red light, as described earlier, resulting in a problem of reduced color reproducibility. This will be described concretely with reference to FIG. 4.

FIG. 4 is a graph showing a spectrum of light from the backlight device 3 and light transmission characteristics (wavelength characteristics for light transmittances) of color filters on display elements. In FIG. 4, the spectrum of light from the backlight device 3 is indicated by a solid line, and light transmission characteristics of red, green, and blue filters are indicated by a broken line, a long dashed and short dashed line, and a long dashed and double-short dashed line, respectively.

As can be appreciated with reference to FIG. 4, the light from the backlight device 3 includes a wavelength component that can be transmitted through both blue and green filters and another wavelength component that can be transmitted through both green and red filters. Accordingly, for example, even in the case where green is desired to be displayed, since green filters transmit therethrough both light within a portion of the wavelength range of the blue light from the backlight device 3 and light within a portion of the wavelength range of the red light from the backlight device 3, the color displayed by the G display elements includes light in such off-centered wavelength ranges. Note that the “off-centered” is intended to mean that the wavelength ranges are away from the center wavelength of the light indicating the color (in the above, green) designed to be displayed on the display device. In this manner, an off-centered color is displayed, resulting in a reduction in color reproducibility.

However, as shown in FIG. 4, the blue light from the LED bare chips 301 occupies a narrower wavelength band (than the wavelength band occupied by each of the green light from the green phosphors 302 and the red light from the red phosphors 303), and has a smaller quantity of wavelength component transmitted through the green filters (i.e., the light intensity at that wavelength is low). Therefore, it can be said that the reduction in color reproducibility is a problem mainly caused between green and red light.

Furthermore, it can be appreciated with reference to FIG. 4 that the light transmission characteristics of the blue and red filters do not overlap with each other, and therefore no light can be transmitted through both of these color filters. Accordingly, so long as the color filters with the light transmission characteristics shown in FIG. 4 are used, the problem with color reproducibility does not occur between the blue and red light.

On the premise of the foregoing, in the present embodiment, alternate lighting control is performed for display that does not require high luminances but satisfactory color reproducibility. In this case, the display control circuit 5 controls the BG-LEDs 34 and the BR-LEDs 35 to be lit up alternatingly every half a frame, the frame being a cycle in which one image is displayed. Note that a half frame will be referred to below as a subframe, and the former and latter halves of a frame will be referred to as the first subframe and the second subframe, respectively. Note that each subframe is also called a field.

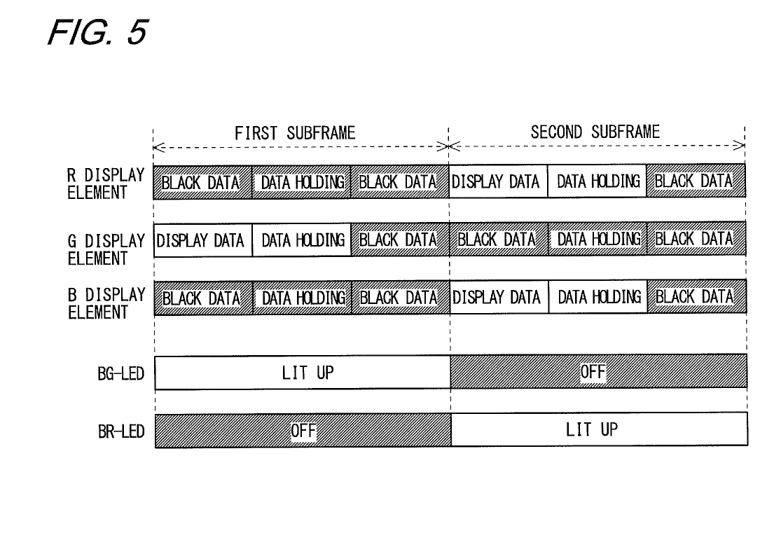

Here, writing liquid crystal data Dₐ to the display elements takes a predetermined period of time because it is necessary to sequentially activate the scanning signal lines, as described earlier. Accordingly, for example, in the case where the G display elements are set at black display while the BG-LEDs 34 are not lit up, it is necessary to complete writing of display tone data at 0 to the G display elements at the latest immediately before the start of the light up. Therefore, one subframe needs to include a period in which to write desired liquid crystal data Dₐ to each display element, a period in which to hold data written for display (but not always requisite), and a period in which to write display tone data for black. This will be further described with reference to FIG. 5.

FIG. 5 is a diagram showing the control timing for both the display operation of each of the R, G, and B display elements and the operation of lighting up LEDs. Initially, in the first subframe, the display control circuit 5 controls the backlight driver circuit 4 to light up the BG-LEDs 34, and also controls the panel driver circuit 6 to set the light transmittance of the G display elements to a desired value. The display control circuit 5 further controls the panel driver circuit 6 to set the light transmittances of the blue and R display elements to zero. To this end, as shown in FIG. 5, liquid crystal data Dₐ (referred to below as “display data”) corresponding to the desired transmittance is written to the G display elements, and liquid crystal data Dₐ (referred to below as “black data”) corresponding to the zero transmittance is written to each of the R and B display elements. Note that it is assumed here that the writing of data takes time equivalent to ⅓ of a subframe (⅙ of a frame). The reason for writing such display data or black data will be described later.

In the first subframe, once the writing is completed, subsequently, the panel driver circuit 6 is controlled to hold data for ⅓ of the subframe (⅙ of a frame). The reason for holding data is to lengthen the display period of display data. Therefore, this data holding operation may be omitted.

In the first subframe, once the data holding period ends, black data is written to each display element. This is to prevent the display data previously written to the G display elements to be maintained at the time of the BR-LEDs 35 being lit up at the beginning of the subsequent second frame period. Therefore, the data holding operation may be continued without writing black data to the R and B display elements.

Furthermore, in the first ⅓ of the second subframe period, black data is written to the G display elements, and therefore the operation of holding the display data may be performed in the last ⅓ of the first subframe period without writing black data. In this case, however, G display pixels to which black data has not yet been written (concretely, all G display pixels whose corresponding scanning signal lines have not yet been activated) in the first ⅓ of the second subframe period transmit light from the BR-LEDs 35 therethrough, so that crosstalk occurs, resulting in a reduction in color reproducibility. Details will be described later.

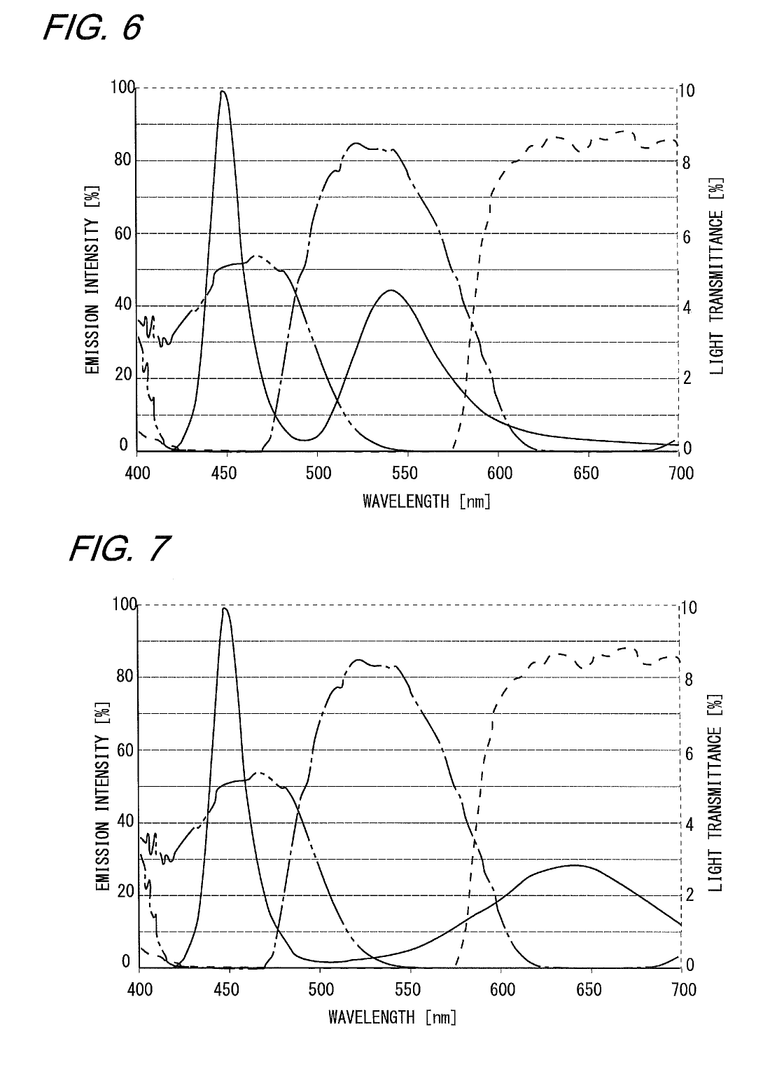

Here, the reason for setting the light transmittances of the B and R display elements at zero during the first subframe period is to transmit light within a portion of the wavelength range of the green light from the BG-LEDs 34 through the blue and red filters, thereby preventing a reduction in color reproducibility of the B and R display elements, as mentioned earlier. This will be concretely described with reference to FIG. 6.

FIG. 6 is a graph showing a spectrum of light from the BG-LEDs and light transmission characteristics (wavelength characteristics for light transmittances) of color filters on display elements. In FIG. 6, the spectrum of light from the BG-LEDs 34 is indicated by a solid line, and light transmission characteristics of color filters of various colors are indicated as in FIG. 4.

As can be appreciated with reference to FIG. 6, the light from the BG-LEDs 34 includes a wavelength component that can be transmitted through the color filters of various colors, but for example, when trying to display red with the light from the BG-LEDs 34, the red filters transmit therethrough off-centered red light that is close to the green wavelength range of the blue-green light from the BG-LEDs 34 (i.e., the red light is away from the center wavelength of the red light designed to be displayed on the display device). As a result, the color obtained by transmission of the light from the BG-LEDs 34 to be displayed by the R display elements is poorly reproduced (i.e., off-centered red). Accordingly, by setting the light transmittance of the R display elements at zero during the first subframe, it is rendered possible to inhibit or eliminate a reduction in color reproducibility. Note that the reason for setting the light transmittance of the B display elements at zero will be described later in conjunction with the following description of the second subframe.

Next, in the second subframe, as shown in FIG. 5, the display control circuit 5 controls the backlight driver circuit 4 to light up the BR-LEDs 35 and also controls the panel driver circuit 6 to set the light transmittance of each of the B and R display elements to a desired value. Moreover, the display control circuit 5 controls the panel driver circuit 6 to set the light transmittance of the G display elements to zero. Note that the reason for necessitating the data holding operation and the reason for writing black data to each display element in the last ⅓ of the second subframe are the same as in the case of the first subframe, and therefore any descriptions thereof will be omitted. Here, the reason for setting the light transmittance of the G display elements at zero during the second subframe will be concretely described with reference to FIG. 7.

FIG. 7 is a graph showing a spectrum of light from the BR-LEDs and light transmission characteristics (wavelength characteristics for light transmittances) of color filters on display elements. In FIG. 7, the spectrum of light from the BR-LEDs 35 is indicated by a solid line, and light transmission characteristics of color filters of various colors are indicated as in FIG. 4.

As can be appreciated with reference to FIG. 7, the light from the BR-LEDs 35 includes a wavelength component that can be transmitted through the color filters of various colors, but for example, when trying to display green with the light from the BR-LEDs 35, the green filters transmit therethrough off-centered green light that is close to the red wavelength range of the purple light from the BR-LEDs 35. As a result, the color obtained by transmission of the light from the BR-LEDs 35 to be displayed by the G display elements is poorly reproduced (i.e., off-centered green). Accordingly, by setting the light transmittance of the G display elements at zero during the second subframe, it is rendered possible to inhibit or eliminate a reduction in color reproducibility.

Here, the reason for setting the light transmittance of the B display elements at zero during the first subframe and controlling the panel driver circuit 6 to set the light transmittance of the B display elements to a desired value in the second subframe can be readily understood by comparing FIGS. 6 and 7. Specifically, to look at the light transmission characteristics of the blue filters, more components of off-centered light close to the green wavelength range of the light transmitted through the blue filters are included (such components have a higher light intensity) in the light from the BG-LEDs 34 shown in FIG. 6 than in the light from the BR-LEDs 35 shown in FIG. 7. Therefore, to display blue, the light from the BR-LEDs 35 shown in FIG. 7 is preferably used because crosstalk is eliminated so that color reproducibility can be enhanced.

However, even in the case where the light from the BR-LEDs 35 shown in FIG. 7 is used, the light intensity of the off-centered light component is not significantly higher than in the case where the light from the BG-LEDs 34 shown in FIG. 6 is used, and therefore, the light from the BG-LEDs 34 shown in FIG. 6 may be used to display blue. Even in such a configuration, the off-centered light component close to the green wavelength range that is transmitted through the blue filters is sufficiently small, so that crosstalk is inhibited. Thus, the effect of inhibiting a reduction in color reproducibility can be achieved.

Furthermore, both in the first subframe and the second subframe (i.e., in one frame), the panel driver circuit 6 may be controlled to set the light transmittance of the B display elements to a desired value (i.e., not to be fixed at zero in one of the subframes).

Here, in the case of alternate lighting control, the display elements of each color provide display only in the first subframe or the second subframe for ⅔ of that subframe (which is the sum of the display data writing period and the data holding period), and therefore the display period is half of ⅓ of a frame. Accordingly, when compared to the case of simultaneous lighting control, the maximum luminance is about ⅓, but a reduction in color reproducibility, which is caused in the case of simultaneous lighting control, can be inhibited or eliminated. In this manner, in the case where color reproducibility is desired to be enhanced, the display control circuit 5 performs alternate lighting control on the basis of, for example, a user operation for mode change selection, and a well-known characteristic determination for image data.

<3. Effect>

As described above, in the present embodiment, on the basis of, for example, a user operation for mode change selection or suchlike, the BG-LEDs 34 and the BR-LEDs 35 are controlled to be lit up at the same time during one frame (simultaneous lighting control), or they are controlled to be lit up alternatingly every half a frame, such that only the G display elements are used for display during the subframe where the BG-LEDs 34 are lit up, and only the B and R display elements are used for display during the subframe where the BR-LEDs 35 are lit up (alternate lighting control). In this manner, by using the BG-LEDs 34 and the BR-LEDs 35, which have high optical output power and are resistant to a reduction in output power due to a temperature change or suchlike, luminances can be increased in the case of simultaneous lighting control and color reproducibility can be enhanced in the case of alternate lighting control.

Particularly in the case of alternate lighting control, the attenuation rate of color filters is increased without reducing pixel luminances, and even in the case where crosstalk occurs (with respect to color filters of a certain color), display elements of colors for which such crosstalk can be inhibited or eliminated are simply used for display so that a reduction in color reproducibility can be inhibited or eliminated.

Furthermore, in the present embodiment, all LEDs are controlled to be off for a total of ⅔ of a frame period in the first and second subframes, so that life of the BG-LEDs 34 and the BR-LEDs 35 can be extended approximately three times.

<4. Variant>

In the embodiment, each of the first and second subframes spans a half of one frame, but in the case of alternate lighting control, the length ratio of the first and second subframes may be changed to adjust luminances of colors (chromaticity adjustment). Moreover, the data holding period spans ⅓ of a subframe, but the period can be appropriately set in accordance with the data writing speed of the panel driver circuit 6.

In the embodiment, the backlight device 3 has a so-called tandem configuration including the light guide plate 36, but it may have a so-called straight-down configuration in which the LEDs functioning as light sources are arranged in a matrix immediately below the liquid crystal panel 7.

Furthermore, the LEDs included in the straight-down backlight device may be grouped row by row so as to be operated as a so-called scan-backlight device. In the scan-backlight device, each row of grouped LEDs are lit up (their lighting states are changed) when a plurality of display rows within a corresponding group on the liquid crystal panel 7 are displayed (concretely, when display tone data is written to all display elements included in the display rows). Specifically, in a display period corresponding to the first subframe for the display rows, a group of BG-LEDs 34 corresponding to the rows are lit up, and in a display period corresponding to the second subframe for the display rows, a group of BR-LEDs 35 corresponding to the rows are lit up. Such an operation is sequentially performed for each group and repeated every frame. In such an operation, the BG-LEDs 34 and the BR-LEDs 35 in their respective groups are not lit up at the same time, the operation (period) of writing black data to all display elements is not required, and therefore data is written to the display elements within ½ of a frame. Accordingly, when compared to the embodiment, the period in which data is written can be lengthened, making it possible to use a lower-speed panel driver circuit and a lower-response-speed liquid crystal.

In the embodiment, in the case of alternate lighting control, display elements of each color provide display in only one of the first and second subframes, but only one or two types of display elements may provide display for one frame period in accordance with a display image. For example, in the case where an image not including red, such as a solid green image, is displayed, the backlight driver circuit 4 may be controlled to light up only the BG-LEDs 34 for one frame period, and the panel driver circuit 6 may be controlled to set the display luminance of the R display elements to zero. Similarly, for example, in the case where an image not including green, such as a solid red image, is displayed, the backlight driver circuit 4 may be controlled to light up only the BR-LEDs 35 for one frame period, and the panel driver circuit 6 may be controlled to set the display luminance of the G display elements to zero.

In the embodiment, the panel driver circuit 6 is controlled to set the light transmittance of display elements, excluding display elements whose light transmittance should be set to a desired value, to zero, but the light transmittance here is not necessarily set to zero and may be set to a value which causes a small reduction in color reproducibility that can be tolerated, so long as transmitted light can be blocked to a great degree. As a result, when compared to the case where the light transmittance is zero so that light is completely blocked, color reproducibility is reduced, but a total display luminance for one frame period can be increased.

In the embodiment, the BG-LEDs 34 and the BR-LEDs 35 are used, but the same or different LEDs may be used, in place of the LED bare chips 301, to emit different colors, or phosphors emitting different colors may be used in place of the green phosphors 302 and the red phosphors 303. Alternatively, illuminants other than LEDs and phosphors may be used.

### INDUSTRIAL APPLICABILITY

The present invention is applied to color image display devices equipped with backlights including light sources of different colors and is suitable for color liquid crystal display devices equipped with backlights including LED light sources.

### DESCRIPTION OF THE REFERENCE CHARACTERS

2 liquid crystal display device
3 backlight
4 backlight driver circuit
5 display control circuit
6 panel driver circuit
7 liquid crystal panel
32 LED unit
34 BR-LED
35 BG-LED
36 light guide plate

1. An active-matrix color image display device, comprising:
a display portion having first through third display elements arranged in a matrix, the display elements having color filters of predetermined three primary colors formed on their respective surfaces and transmitting light with transmittances in accordance with provided signals;
a drive control portion for providing the second display elements with signals for image display in a first subframe period being one of two subframe periods into which each frame period for display of one screen is divided, and also providing the first and third display elements with signals for image display in a second subframe period being the other of the two subframe periods;
a backlight portion including first illuminants for emitting light of first and second colors among the three primary colors and second illuminants for emitting light of the first color and a third color among the three primary colors, at least one of the first and second illuminants being lit up to illuminate the display portion; and
a backlight control portion for controlling the first illuminants to be lit up and the second illuminants to be turned off during the first subframe period and also controlling the first illuminants to be turned off and the second illuminants to be lit up during the second subframe period, wherein,
the drive control portion provides the first and third display elements with signals for setting their light transmittances to zero or a value close to zero in the first subframe period and also provides the second display elements with signals for setting their light transmittances to zero or a value close to zero in the second subframe period.

2. The color image display device according to claim 1, wherein the first color is blue, the second color is green, and the third color is red.

3. The color image display device according to claim 1, wherein,
the first illuminants include light-emitting diode elements for emitting the first color and first phosphors for emitting the second color when being excited by light from the light-emitting diode elements, and
the second illuminants include light-emitting diode elements of the same type as the light-emitting diode elements included in the first illuminants and second phosphors for emitting the third color when being excited by light from the light-emitting diode elements included in the second illuminants.

4. The color image display device according to claim 1, wherein the color filters formed on the first display elements transmit therethrough both light of the first color and a portion of light of the second color that has a wavelength close to the first color, and block light of the third color.

5. The color image display device according to claim 1, wherein the backlight control portion in a predetermined first operation mode controls the first and second illuminants such that the first illuminants are lit up with the second illuminants off during the first subframe period, the first illuminants are turned off with the second illuminants lit up during the second subframe period, and in a second operation mode where the display elements have higher display luminances than in the first operation mode, the backlight control portion controls the first and second illuminants to be lit up during each frame period.

6. A method for controlling an active-matrix color image display device with a display portion having first through third display elements arranged in a matrix, the display elements having color filters of predetermined three primary colors formed on their respective surfaces and transmitting light with transmittances in accordance with provided signals, and a backlight portion including first illuminants for emitting light of first and second colors among the three primary colors and second illuminants for emitting light of the first color and a third color among the three primary colors, at least one of the first and second illuminants being lit up to illuminate the display portion, the method comprising:
a drive control step of providing the second display elements with signals for image display in a first subframe period being one of two subframe periods into which each frame period for display of one screen is divided, and also providing the first and third display elements with signals for image display in a second subframe period being the other of the two subframe periods; and
a backlight control step of controlling the first illuminants to be lit up and the second illuminants to be turned off during the first subframe period and also controlling the first illuminants to be turned off and the second illuminants to be lit up during the second subframe period, wherein,
in the drive control step, the first and third display elements are provided with signals for setting their light transmittances to zero or a value close to zero in the first subframe period, and the second display elements are provided with signals for setting their light transmittances to zero or a value close to zero in the second subframe period.
